(19) United States
(12) Patent Application Publication
(10) Pub. No.: US 2026/0106290 A1
(43) Pub. Date: Apr. 16, 2026

(54) BATTERY PACK CASE AND BATTERY PACK COMPRISING SAME

(71) Applicant: SK ON CO., LTD., Seoul (KR)

(72) Inventor: Kyung Hee JEONG, Daejeon (KR)

(21) Appl. No.: 19/116,333

(22) PCT Filed: Apr. 19, 2023
(86) PCT No.: PCT/KR2023/005263

§ 371 Date: Mar. 27, 2025

(30) Foreign Application Priority Data
Sep. 28, 2022 (KR) 10-2022-0123669

(51) Int. Cl. H01M 50/24; A62C 3/16; A62C 35/13; H01M 10/647; H01M 10/658; H01M 50/211; H01M 50/291

(52) U.S. Cl. CPC H01M 50/24; A62C 3/16; A62C 35/13; H01M 10/647; H01M 10/658; H01M 50/211; H01M 50/291

(57) ABSTRACT

A battery pack case is disclosed. The battery pack case of the present disclosure may include: a bottom plate; a side case extending upward from a periphery of the bottom plate, and forming an accommodation space together with the bottom plate; and a partition unit positioned on an upper surface of the bottom plate, and configured to partition the accommodation space, wherein the partition unit includes: a partition support module coupled to the bottom plate; and a partition insulation module coupled to the partition support module, and forming an insulation space as a hollow section therein.

### CROSS-REFERENCE TO RELATED APPLICATION

This patent application is a national stage application of PCT/KR2023/005263 filed on Apr. 19, 2023, which claims the priority and benefits of Korean patent application No. 10-2022-0123669, filed on Sep. 28, 2022, the disclosure of which is incorporated herein by reference in its entirety.

### TECHNICAL FIELD

The embodiments of the present disclosure relate generally to a battery pack case and a battery pack including the same. In particular, the present disclosure relates to a battery pack case that suppresses fire propagation between battery cells by using an insulation space formed therein and a battery pack including the battery pack case.

### BACKGROUND ART

If a fire occurs in a battery cell of a secondary battery due to overcurrent or overheating, the flames may spread to adjacent other battery cells. In this case, a plurality of battery cells may ignite sequentially, resulting in a chain reaction of fires.

In particular, in the case of an electric vehicle equipped with a battery module consisting of a plurality of secondary battery cells or an electric vehicle equipped with the plurality of secondary battery cells, if flame propagation between battery cells or battery modules is not effectively suppressed, the safety of passengers in the electric vehicle may be at risk. Therefore, a structure capable suppressing flame propagation between the battery cells is required in a battery pack case used in the electric vehicle or the like.

(Patent Document 1) KR 10-2282482 B1

### SUMMARY

An embodiment of the present disclosure addresses the above-mentioned problems as well as other related problems.

Another embodiment of the present disclosure provides a battery pack case that suppresses fire transfer between a plurality of battery modules and a battery pack including the same.

In addition, another embodiment of the present disclosure provides a battery pack case that prevents fire transfer between partitioned accommodation spaces and a battery pack including the same.

Further, another embodiment of the present disclosure provides a battery pack case in which a partition unit serving as a cross member has an insulation space and a battery pack including the same.

Further, another embodiment of the present disclosure provides a battery pack case in which a side insulation space is formed in a side case and a battery pack including the same.

Furthermore, another embodiment of the present disclosure provides a battery pack case that releases a fire extinguishing agent when the pressure in a hollow section is a predetermined pressure or more and a battery pack including the same.

According to an embodiment of the present disclosure, there is provided a battery pack case including: a bottom case; a side case extending upward from a periphery of the bottom case, and forming a accommodation space together with the bottom case; and a partition unit positioned on an upper surface of the bottom case, and configured to partition the accommodation space, wherein the partition unit includes: a partition support module coupled to the bottom case; and a partition insulation module coupled to the partition support module, and forming an insulation space as a hollow section therein.

According to another embodiment of the present disclosure, there is provided a battery pack including: a plurality of battery cell groups each containing a plurality of battery cells; and a battery pack case configured to accommodate a plurality of battery groups, wherein the battery pack case includes: a bottom case; a side case extending upward from a periphery of the bottom case, and forming a accommodation space together with the bottom case; and a partition unit positioned on an upper surface of the bottom case, and configured to partition the accommodation space, wherein the partition unit includes: a partition support module coupled to the bottom case; and a partition insulation module coupled to the partition support module, and forming an insulation space as a hollow section therein.

The effects of the battery pack case according to the present disclosure will be described as follows.

According to at least one of the embodiments of the present disclosure, a battery pack case that suppresses fire transfer between the plurality of battery modules and a battery pack including the same may be provided.

According to at least one of the embodiments of the present disclosure, a battery pack case that prevents fire transfer between the partitioned accommodation spaces and a battery pack including the same may be provided.

According to at least one of the embodiments of the present disclosure, a battery pack case in which a partition unit serving as the cross member has the insulation space and a battery pack including the same may be provided.

According to at least one of the embodiments of the present disclosure, a battery pack case having the side insulation space formed in the side case and a battery pack including the same may be provided.

According to at least one of the embodiments of the present disclosure, a battery pack case that releases a fire extinguishing agent when the pressure in the hollow section is a predetermined pressure or more a predetermined pressure and a battery pack including the same may be provided.

Additional scopes of applicability of the present disclosure will become apparent from the following detailed description. However, since various alternations and modifications within the technical idea and scope of the present disclosure may be clearly understood by those skilled in the art, it should be understood that the detailed description and specific embodiments, such as preferred embodiments of the present disclosure, are provided for illustrative purposes only.

### BRIEF DESCRIPTION OF DRAWINGS

FIG. 1 is a perspective view illustrating a battery pack case according to an embodiment of the present disclosure;

FIG. 2 is a perspective view illustrating a battery pack case having a second partition unit formed therein according to an embodiment of the present disclosure;

FIG. 3 is a cross-sectional view of the battery pack case shown in FIG. 1 taken on line A-A;

FIG. 4 is a detailed cross-sectional view illustrating the insulation module of FIG. 3;

FIG. 5 is a cross-sectional view of the partition unit shown in FIG. 1 taken on line A-A, illustrating a first partition insulation module and a second partition insulation module which are spaced apart from each other;

FIG. 6 is a detailed cross-sectional view illustrating the first partition insulation module and the second partition insulation module of FIG. 5;

FIG. 7 is a cross-sectional view of the partition unit shown in FIG. 1 taken on line A-A, illustrating a state in which an insulation member is disposed between the first partition insulation module and the second partition insulation module;

FIG. 8 is a cross-sectional view of the partition unit shown in FIG. 1 taken on line A-A, illustrating a state in which a partition insulation module is disposed between the first partition support module and the second partition support module;

FIG. 9 is a cross-sectional view of the battery pack case shown in FIG. 1 taken on line B1-B2;

FIG. 10 is a detailed cross-sectional view of the side insulation module shown in FIG. 9;

FIG. 11 is a cross-sectional view of the partition unit shown in FIG. 1 taken on line A-A, illustrating a state in which a extinguishing part is formed in the partition leg part;

FIG. 12 is a detailed view illustrating a portion ‘C’ of FIG. 11;

FIG. 13 is a cross-sectional view of the battery pack case shown in FIG. 1, illustrating a state in which a portion of a bottom case is formed integrally with the partition support module;

FIG. 14 is a perspective view illustrating a battery module according to an embodiment of the present disclosure;

FIG. 15 is a perspective view illustrating a battery cell group according to an embodiment of the present disclosure;

FIG. 16 is a perspective view illustrating the battery modules accommodated in the battery pack case; and

FIG. 17 is a perspective view illustrating the battery cell groups accommodated in the battery pack case.

### DETAILED DESCRIPTION

Hereinafter, the embodiments disclosed in this specification will be described in detail with reference to the accompanying drawings, wherein the same reference numerals denote the same components regardless of the number of the drawings, and the same configuration will not be repeatedly described. The suffixes “module” and “part” used for components in the following description are provided or used interchangeably only for the sake of convenience of drafting the specification, and do not have distinct meanings or roles by themselves. In addition, in describing the embodiments disclosed in this specification, well-known techniques related to the present disclosure, which may unnecessarily obscure the essence of the disclosure, will not be described in detail. Furthermore, the accompanying drawings are provided solely to aid in the understanding of the embodiments disclosed in this specification, and it should be understood that the technical ideas disclosed herein are not limited by the accompanying drawings, as well as all modifications, equivalents and substitutes within in the scope of the disclosure and technology scope are included.

It will be understood that, terms including ordinal numbers such as “first,” “second,” etc. may be used to describe various components, but these components are not limited by these terms. These terms are used solely to distinguish one component from other components.

It will be understood that when a component is referred to as being “connected to” or “coupled to” another component, it may be directly connected or coupled to the other component, but another intervening component may be present therebetween. In contrast, when a component is referred to as being “directly connected to” or “directly coupled to” another component, no intervening component is present.

As used herein, the singular forms “a,” “an,” and “the” are intended to include the plural forms as well, unless the context clearly indicates otherwise.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

In the drawings, the sizes of components may be exaggerated or reduced for convenience of description. For example, since the sizes and thicknesses of each component shown in the drawings are arbitrarily depicted for convenience of description, the present disclosure is not necessarily limited to what is shown.

In the case where some embodiments may be implemented differently, specific process orders may be performed in a different sequence from the described order. For example, two processes described in succession may be performed substantially simultaneously or may be performed in the reverse order of the described order.

In the following embodiments, when a film, region, component, etc. is mentioned to be “connected,” it includes not only the case where the films, regions and components are directly connected, but also the case where other films, regions and components are interposed between the films, regions and components, and are indirectly connected. For example, in the present specification, when a film, region or component, etc. is mentioned to be “electrically connected,” it includes not only the case where the films, regions and components are directly electrically connected, but also the cases where other films, regions and components are interposed between them and are indirectly electrically connected.

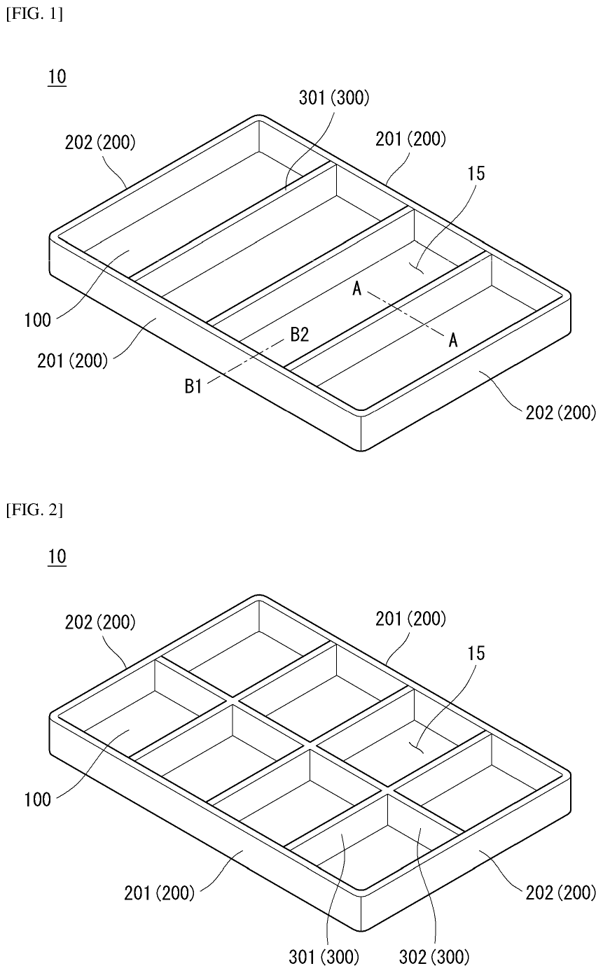

FIG. 1 is a perspective view illustrating a battery pack case according to an embodiment of the present disclosure.

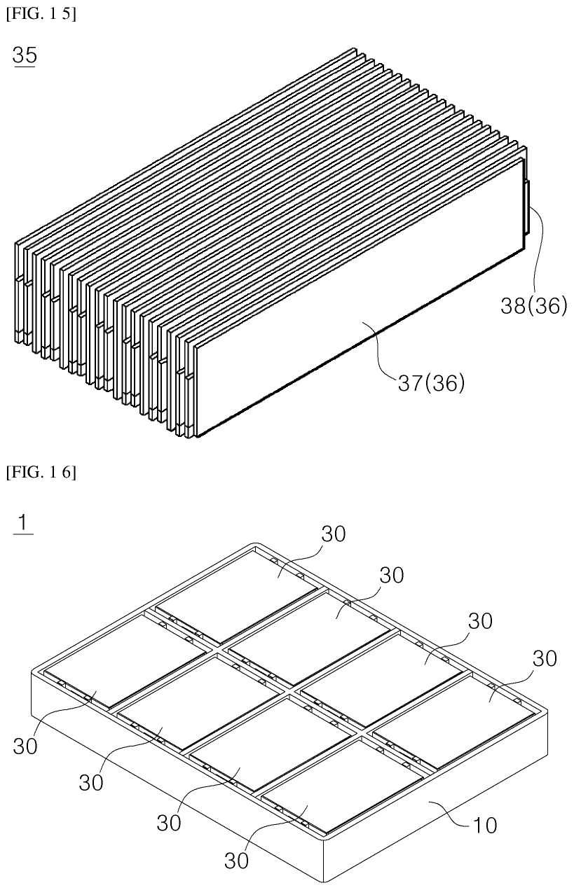

Referring to FIG. 1, a battery pack case 10 may accommodate at least one battery module 30 (see FIG. 14). The battery module 30 (see FIG. 14) may include a plurality of battery cells 36 (see FIG. 15). A battery pack 1 (see FIG. 16) may include the battery pack case 10 and the battery module 30 (see FIG. 14).

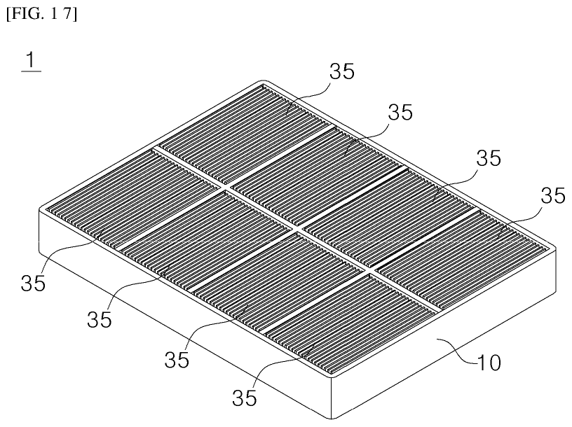

The battery pack 1 (see FIGS. 16 and 17) may be installed in, for example, an electric vehicle to serve as an electric power source of an energy storage unit for the electric vehicle. The battery pack 1 (see FIGS. 16 and 17) may be installed in, for example, a lower portion of the electric vehicle.

The battery pack case 10 may accommodate the plurality of battery cells 36 (see FIG. 15). For example, the plurality of battery cells 36 (see FIG. 15) may be assembled into the battery module 30 (see FIG. 14) and then accommodated in the battery pack case 10.

For another example, the plurality of battery cells 36 (see FIG. 15) may be accommodated directly in the battery pack case 10. That is, the battery pack 1 may include the battery pack case 10 and the plurality of battery cells 36 housed therein (see FIG. 15).

In the event of a fire in a battery cell, the fire may easily spread to neighboring battery cells or neighboring battery modules. Therefore, a structure that suppresses the spread of fire in the battery cell may be required in the battery pack case 10.

The battery pack case 10 may include a bottom case 100. The bottom case 100 may be positioned below at least one battery module 30 (see FIG. 14) or the plurality of battery cells 36 (see FIG. 15). The bottom case 100 may form, for example, the bottom of the battery pack case 10. The bottom case 100 may form, for example, a lower surface (or bottom surface) of the electric vehicle.

The bottom case 100 may be formed in a plate shape. The bottom case 100 may be formed in a rectangular shape overall. For example, the upper surface and the lower surface of the bottom case 100 may have a rectangular shape.

That is, both the upper and the lower surfaces of the bottom case 100 may have a rectangular shape. For example, the four sides of the bottom case 100 may consist of two short edges and two long edges.

For example, the bottom case 100 may be formed in a shape extending from one side to the other side, i.e., the opposite side. The one side and the opposite side of the bottom case 100 may correspond to the short edges of the bottom case 100.

The two long edges of the bottom case 100 may connect the two short edges of the bottom case 100. A direction in which the bottom case 100 extends may correspond to the length direction of the battery pack case 10, while a direction connecting the two long edges of the bottom case 100 may correspond to the width direction of the battery pack case 10.

The battery pack case 10 may include a side case 200. The side case 200 may be formed along edges of the bottom case 100. For example, the side case 200 may extend upward from an edge or an edge portion of the bottom case 100.

The side case 200 may include a first side case 201. The first side case 201 may be formed along the long edge or the long edge portion of the bottom case 100. For example, the first side case 201 may be formed in a shape extending upward from the long edge or the long edge portion of the bottom case 100. The first side case 201 may be formed in a shape extending in the length direction of the battery pack case 10.

A plurality of first side case 201 may be provided. For example, the first side case 201 may include a pair of first side cases 201. The pair of first side cases 201 may be formed in a shape extending upward from each of the two long edges of the bottom case 100. The pair of first side cases 201 may be spaced apart from and positioned to face each other. A direction in which the pair of first side cases 201 face each other may correspond to the width direction of the battery pack case 10.

The side case 200 may include a second side case 202. The second side case 202 may be formed along the short edge portion or the short edge portion of the bottom case 100. For example, the second side case 202 may be formed in a shape extending upward from the short edge or the short edge portion of the bottom case 100. The second side case 202 may be formed in a shape extending in the width direction of the battery pack case 10.

A plurality of second side case 202 may be provided. For example, the second side case 202 may include a pair of second side cases 202. The pair of second side cases 202 may be formed in a shape extending upward from each of the two short edges of the bottom case 100. The pair of second side cases 202 may be spaced apart from and positioned to face each other. A direction in which the pair of second side cases 202 face each other may correspond to the length direction, i.e., the longitudinal direction of the battery pack case 10.

The side case 200 and the bottom case 100 may form an accommodation space 15. An upper portion of the accommodation space 15 may open. The accommodation space 15 may be a space in which the battery module or the battery cell is positioned. The bottom case 100 and the side case 200 may define a boundary of the accommodation space 15.

The battery pack case 10 may include a partition unit 300. The partition unit 300 may be positioned on an upper surface of the bottom case 100. The partition unit 300 may be positioned in the accommodation space 15. The partition unit 300 may be formed in a shape extending upward from the upper surface of the bottom case 100.

The partition unit 300 may be surrounded by the side case 200. For example, the partition unit 300 may be positioned between the pair of first side cases 201. For example, the partition unit 300 may be positioned between the pair of second side cases 202.

The partition unit 300 may include a first partition unit 301. The first partition unit 301 may be connected or coupled to the first side case 201. The first partition unit 301 may extend from one of the pair of first side cases 201 to the other of the pair of first side cases 201. The first partition unit 301 may be formed in a shape extending in the width direction of the battery pack case 10.

The partition unit 300 may partition the accommodation space 15 into a plurality of accommodation spaces. For example, the plurality of accommodation spaces 15, partitioned by the first partition unit 301 may be arranged in the length direction of the battery pack case 10.

FIG. 2 is a perspective view illustrating a battery pack case having a second partition unit formed therein according to an embodiment of the present disclosure.

Referring to FIG. 2, the partition unit 300 may include a second partition unit 302. The second partition unit 302 may be connected or coupled to the second side case 202.

The second partition unit 302 may extend from one of the pair of second side cases 202 to the other of the pair of second side cases 202. The second partition unit 302 may be formed in a shape extending in the length direction of the battery pack case 10.

The second partition unit 302 may partition the accommodation space 15 into a plurality of accommodation spaces. For example, the plurality of accommodation spaces 15 partitioned by the second partition unit 302 may be arranged in the width direction of the battery pack case 10. The second partition unit 302 and the first partition unit 301 may intersect each other.

The first partition unit 301 and the second partition unit 302 may intersect with each other. As the first partition unit 301 and the second partition unit 302 intersect, the battery pack case 10 may generally form a lattice shape.

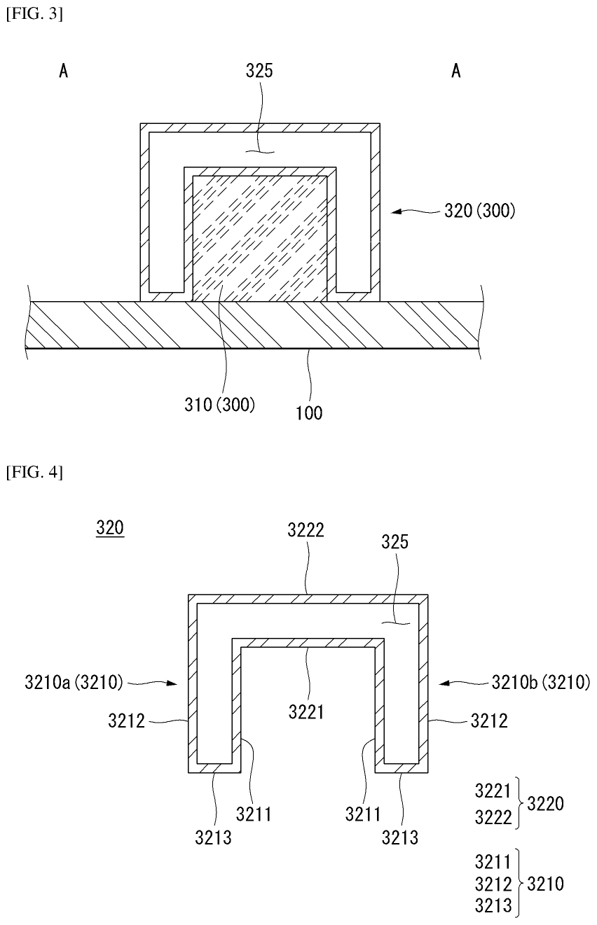

FIG. 3 is a cross-sectional view of the battery pack case shown in FIG. 1 taken on line A-A.

Referring to FIG. 3, the partition unit 300 may include a partition support module 310. The partition support module 310 may be disposed on the upper surface of the bottom case 100. The partition support module 310 may be coupled or fixed to the upper surface of the bottom case 100.

For example, the partition support module 310 may be welded to the upper surface of the bottom case 100. For example, the partition support module 310 may be attached to the upper surface of the bottom case 100 by an adhesive. The partition support module 310 may provide enhanced rigidity to at least one of the bottom case 100 and the side case 200 (see FIG. 1).

The partition unit 300 may include a partition insulation module 320. The partition insulation module 320 may be coupled to the partition support module 310. For example, the partition insulation module 320 may cover upper and side surfaces of the partition support module 310. For example, the partition insulation module 320 may face the battery module 30 (see FIG. 14) or the battery cell 36 (see FIG. 15).

The partition insulation module 320 may form a partition insulation space 325. The partition insulation space 325 may be a hollow section formed in the partition insulation module 320. The pressure in the partition insulation space 325 may be less than 1 atm. For example, the pressure in the partition insulation space 325 may approach 0 atm. In this context, the partition insulation module 320 may be referred to as a “vacuum structure.”

The partition insulation space 325 may exhibit relatively superior insulation performance. In the event of a fire on one side of the partition unit 300, the partition insulation space 325 may suppress heat caused by the fire from transmitting to the other side of the partition unit 300.

FIG. 4 is a detailed cross-sectional view illustrating the insulation module of FIG. 3.

Referring to FIG. 4, the partition insulation module 320 may include a partition leg part 3210 and a partition head part 3220. The partition leg part 3210 may face the side surface of the partition support module 310 (see FIG. 3).

The partition leg part 3210 may include first partition leg plates 3211. The first partition leg plates 3211 may face the partition support module 310 (see FIG. 3).

The partition leg part 3210 may include second partition leg plates 3212. The second partition leg plates 3212 may be positioned on the opposite side of the first partition leg plates 3211. The second partition leg plates 3212 may face the battery module 30 (see FIG. 14) or the battery cell 36 (see FIG. 15).

The partition leg part 3210 may include third partition leg plates 3213. The third partition leg plates 3213 may connect the first partition leg plates 3211 and the second partition leg plates 3212.

For example, the third partition leg plates 3213 may connect lower end portions of the first partition leg plates 3111 and lower end portions of the second partition leg plates 3212. The third partition leg plates 3213 may form the bottom of the partition leg part 3210.

The third partition leg plates 3213 may face the bottom case 100 (see FIG. 1). For example, the third partition leg plates 3213 may be fixed, coupled or attached to the bottom case 100 (see FIG. 1).

The partition leg part 3210 may include a plurality of partition leg parts 3210. For example, the partition leg part 3210 may include a first partition leg part 3210a and a second partition leg part 3210b. The first partition leg part 3210a and the second partition leg part 3210b may be positioned with the partition support module 310 (see FIG. 3) interposed therebetween.

A hollow section may be formed within the partition leg part 3210. For example, the hollow section formed inside the partition leg part 3210 may constitute a portion of the partition insulation space 325.

The partition head part 3220 may be disposed on the partition support module 310 (see FIG. 3). The partition head part 3220 may connect the first partition leg part 3210a and the second partition leg part 3210b. A hollow section may be formed inside the partition head part 3220. For example, the hollow section formed inside the partition head part 3220 may constitute another portion of the partition insulation space 325.

The hollow section formed in the partition head part 3220 may be connected to the hollow sections formed in the partition leg part 3210. The partition insulation space 325 may include the hollow sections formed in the partition leg part 3210 and the hollow section formed in the partition head part 3220.

The partition head part 3220 may include a first partition head plate 3221. The first partition head plate 3221 may face the partition support module 310 (see FIG. 3). The first partition head plate 3221 may be connected to the first partition leg plates 3211.

For example, the first partition head plate 3221 may extend from an upper end of the first partition leg plate 3211 of the first partition leg part 3210a to an upper end of the first partition leg plate 3211 of the second partition leg part 3210b.

The partition head part 3220 may include a second partition head plate 3222. The second partition head plate 3222 may be spaced apart from the first partition head plate 3221 and positioned above the first partition head plate 3221. The second partition head plate 3222 may define an upper surface of the partition head part 3220.

The second partition head plate 3222 may be connected to the second partition leg plates 3212. For example, the second partition head plate 3222 may extend from an upper end of the second partition leg plate 3212 of the first partition leg part 3210a to an upper end of the second partition leg plate 3212 of the second partition leg part 3210b.

The partition insulation module 320 may be made of a material including metal. In this case, in the event of a fire on one side of the partition unit 300 (see FIG. 3), heat caused by the fire may be conducted along the partition head part 3220 and transmitted to the other side of the partition unit 300 (see FIG. 3).

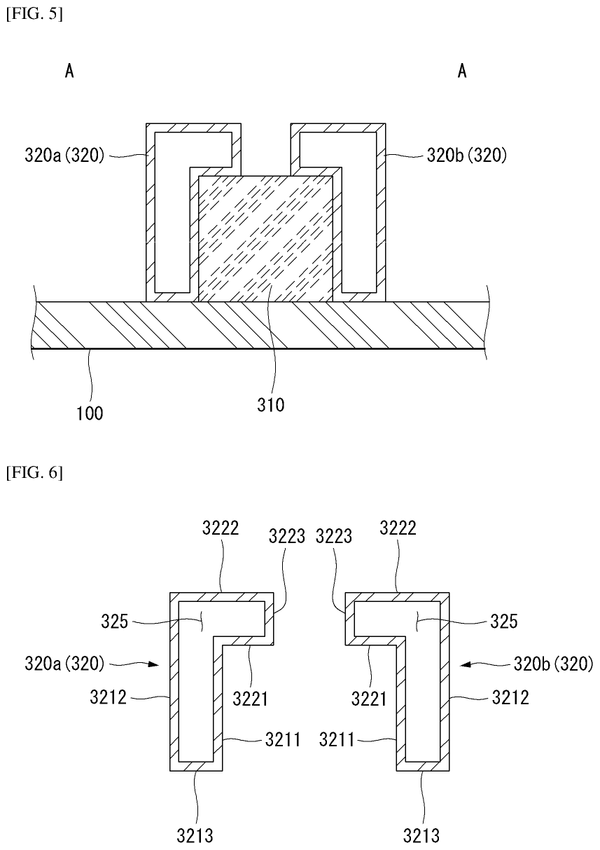

FIG. 5 is a cross-sectional view of the partition unit shown in FIG. 1 taken on line A-A, illustrating a first partition insulation module and a second partition insulation module which are spaced apart from each other. FIG. 6 is a detailed cross-sectional view illustrating the first partition insulation module and the second partition insulation module of FIG. 5.

Referring to FIGS. 5 and 6, the partition insulation module 320 may include a first partition insulation module 320a and a second partition insulation module 320b. The first partition insulation module 320a and the second partition insulation module 320b may be spaced apart from each other. The first partition insulation module 320a and the second partition insulation module 320b may face each other. The partition support module 310 may be positioned between the first partition insulation module 320a and the second partition insulation module 320b.

Each of the first partition insulation module 320a and the second partition insulation module 320b may include partition leg parts 3211, 3212 and 3213. The partition leg parts 3211, 3212 and 3213 may include first partition leg plates 3211, second partition leg plates 3212 and third partition leg plates 3213.

Each of the first partition insulation module 320a and the second partition insulation module 320b may include partition head parts 3221, 3222 and 3223. The partition head parts 3221, 3222 and 3223 may include first partition head plates 3221, second partition head plates 3222 and third partition head plates 3223.

The first partition head plate 3221 may be formed in a shape that is bent and extends from the upper end of the first partition leg plate 3211. The second partition head plate 3222 may be formed in a shape that is bent and extends from the upper end of the second partition leg plate 3212. The third partition head plate 3223 may connect an end of the first partition head plate 3221 and an end of the second partition head plate 3222.

The third partition head plate 3223 of the first partition insulation module 320a may be spaced apart from and positioned to face the third partition head plate 3223 of the second partition insulation module 320b. In the event of a fire in a battery cell adjacent to the first partition insulation module 320a, heat conducted along the first partition insulation module 320a may be effectively blocked from being transmitted to the second partition insulation module 320b.

However, radiant heat generated from the third partition head plate 3223 of the first partition insulation module 320a may be transmitted to the third partition head plate 3223 of the second partition insulation module 320b. In other words, heat may be transmitted from the third partition head plate 3223 of the first partition insulation module 320a to the third partition head plate 3223 of the second partition insulation module 320b through thermal radiation.

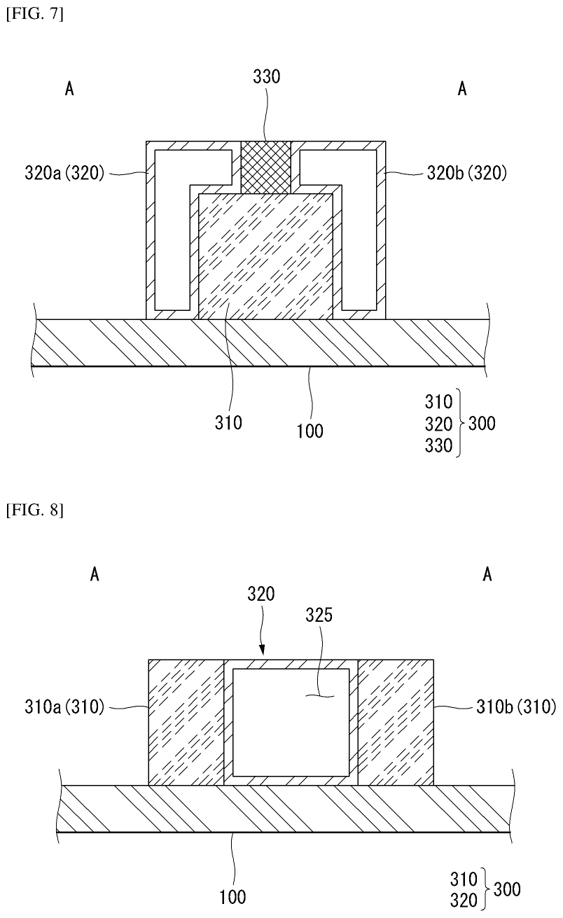

FIG. 7 is a cross-sectional view of the partition unit shown in FIG. 1 taken on line A-A, illustrating a state in which an insulation member is disposed between the first partition insulation module and the second partition insulation module.

Referring to FIGS. 6 and 7, the partition unit 300 may include an insulation member 330. The insulation member 330 may be disposed between the first partition insulation module 320a and the second partition insulation module 320b.

The insulation member 330 may be made of a substance including a material having relatively low thermal conductivity. For example, the insulation member 330 may be made of a material including a polymeric material. For example, the insulation member 330 may include polypropylene (PP) and/or glass wool.

The insulation member 330 may suppress radiant heat generated from the third partition head plate 3223 of the first partition insulation module 320a from being transmitted to the third partition head plate 3223 of the second partition insulation module 320b.

FIG. 8 is a cross-sectional view of the partition unit shown in FIG. 1 taken on line A-A, illustrating a state in which a partition insulation module is disposed between the first partition support module and the second partition support module.

Referring to FIG. 8, a plurality of partition support modules 310 may be provided. For example, the partition support module 310 may include a first partition support module 310a and a second partition support module 310b.

The first partition support module 310a and the second partition support module 310b may be arranged horizontally. The first partition support module 310a and the second partition support module 310b may be spaced apart from each other. The first partition support module 310a and the second partition support module 310b may be coupled or fixed to the upper surface of the bottom case 100.

The partition insulation module 320 may be disposed between the first partition support module 310a and the second partition support module 310b. The partition insulation module 320 may be coupled or fixed to the upper surface of the bottom case 100.

The partition insulation module 320 may form a hollow section therein. For example, the partition insulation module 320 may include a partition insulation space 325 formed therein. In the event of a fire in a battery cell adjacent to the first partition support module 310a, the partition insulation space 325 may suppress heat from transmitting to the second partition support module 310b.

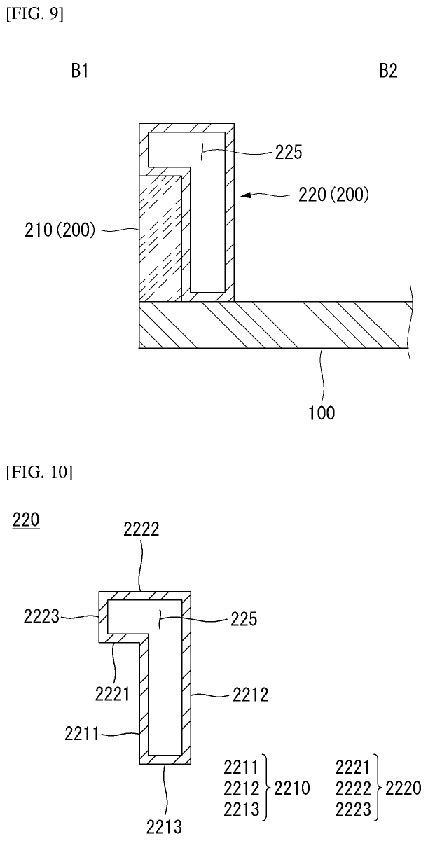

FIG. 9 is a cross-sectional view of the battery pack case shown in FIG. 1 taken on line B1-B2. FIG. 10 is a detailed cross-sectional view of the side insulation module shown in FIG. 9.

Referring to FIGS. 9 and 10, the side case 200 may include the side support module 210 and the side insulation module 220. The side support module 210 may be formed in a shape extending upward from an end of the bottom case 100. The side support module 210 may ensure the rigidity of the side case 200. The side support module 210 may define an outer surface of the side case 200.

The side insulation module 220 may face the side support module 210. The side insulation module 220 may be connected or coupled to the side support module 210. The side insulation module 220 may face an inner surface of the side support module 210. The inner surface of the side support module 210 may face the accommodation space 15 (see FIG. 1).

The side insulation module 220 may face an upper surface of the side support module 210. The side insulation module 220 may form a side insulation space 225 therein as a hollow section. The side insulation module 220 may face the battery module 30 (see FIG. 14) or the battery cell 36 (see FIG. 15).

The side insulation module 220 may include a side leg part 2210. The side leg part 2210 may include a first side leg plate 2211. The first side leg plate 2211 may face the inner surface of the side support module 210.

The side leg part 2210 may include a second side leg plate 2212. The second side leg plate 2212 may be positioned on the opposite side of the first side leg plate 2211. The first side leg plate 2211 may be positioned between the second side leg plate 2212 and the side support module 210.

The side leg part 2210 may include a third side leg plate 2213. The third side leg plate 2213 may connect the first side leg part 2211 and the second side leg part 2212. For example, the third side leg plate 2213 may extend from a lower end of the first side leg part 2211 and be connected to a lower end of the second side leg part 2212. The third side leg plate 2213 may face the bottom case 100.

The side insulation module 220 may include a side head part 2220. The side head part 2220 may face the upper surface of the side support module 210. The side head part 2220 may be formed in a shape that is bent and extends from an upper end of the side leg part 2210.

The side head part 2220 may include a first side head plate 2221. The first side head plate 2221 may be formed in a shape that is bent and extends from an upper end of the first side leg plate 2211. The first side head plate 2221 may face the side support module 210.

The side head part 2220 may include a second side head plate 2222. The second side head plate 2222 may be formed in a shape that is bent and extends from an upper end of the second side leg plate 2212. The second side head plate 2222 may define an upper surface of the side head part 2220.

The side head part 2220 may include a third side head plate 2223. The third side head plate 2223 may connect the first side head plate 2221 and the second side head plate 2222. For example, the third side head plate 2223 may extend from an end of the first side head plate 2221 and be connected to the second side head plate 2222. The third side head plate 2223 may define an outer surface of the side head part 2220.

For example, when the battery pack case 10 (see FIG. 1) is installed in the lower portion of the vehicle, there is a risk that the fire may spread to the entire vehicle if the flame spreads to the outside of the side case 200. In this regard, in the event of a fire in the battery module or battery cell accommodated in the accommodation space 15 (see FIG. 1), the side insulation module 220 may suppress the heat from being transmitted to the exterior.

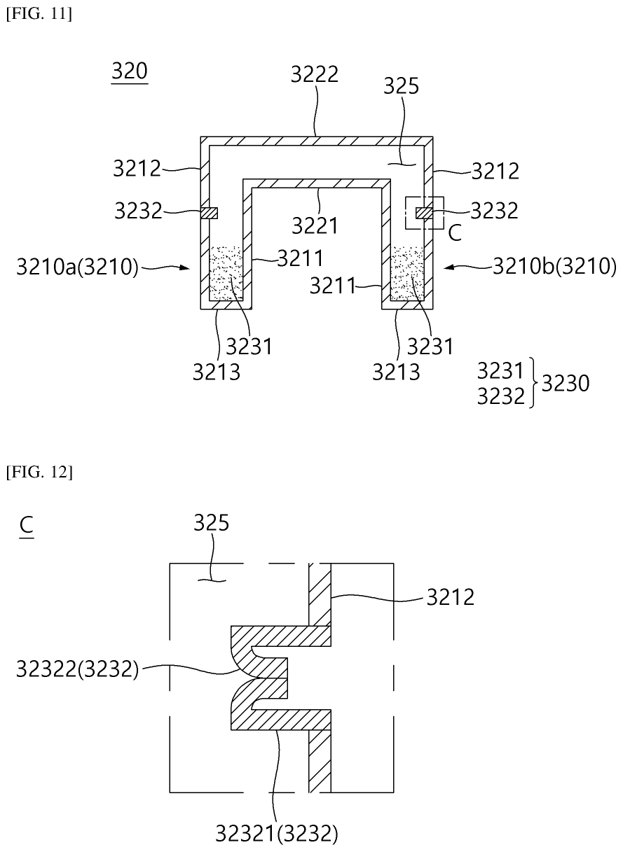

FIG. 11 is a cross-sectional view of the partition unit shown in FIG. 1 taken on line A-A, illustrating a state in which a extinguishing part is formed in the partition leg part. FIG. 12 is a detailed view illustrating a portion ‘C’ of FIG. 11.

Referring to FIGS. 11 and 12, the partition unit 300 (see FIG. 1) may include an extinguishing part 3230. For example, the partition insulation module 320 may include the extinguishing part 3230.

For example, the extinguishing part 3230 may be coupled or positioned in the partition leg part 3210. For example, the extinguishing part 3230 may be coupled or positioned in the partition head parts 3221 and 3222.

For another example, the side insulation module 220 (see FIG. 10) may include the extinguishing part 3230. For example, the extinguishing part 3230 may be coupled or positioned in the side leg part 2210. For example, the extinguishing part 3230 may be coupled or positioned in the side head part 2220.

The extinguishing part 3230 may include an extinguishing agent 3231. The extinguishing agent 3231 may be used to extinguish a fire in the event of a fire. The extinguishing agent 3231 may be in at least one of a liquid state, solid state, gaseous state and powder state.

The extinguishing agent 3231 may be positioned in the partition insulation space 325. The extinguishing agent 3231 may be disposed, for example, in the insulation space 325 of the partition leg part 3210.

The extinguishing part 3230 may include an ejection unit 3232. The ejection unit 3232 may connect the interior and exterior of the partition insulation module 320. The ejection unit 3232 may be coupled or formed, for example, in the partition leg part 3210. For example, the ejection unit 3232 may be coupled or formed in a second partition leg plate 3212.

The ejection unit 3232 may include an ejection unit body 32321. The ejection unit body 32321 may be coupled to the second partition leg plate 3212. The ejection unit body 32321 may be formed in an extended shape from the second partition leg plate 3212.

The ejection unit body 32321 may be formed in a shape protruding toward the partition insulation space 325 from the second partition leg plate 3212. One end of the ejection unit body 32321 may be connected or coupled to the second partition leg plate 3212.

The ejection unit 3232 may include an ejection valve 32322. The ejection valve 32322 may be formed in a shape extending from the other end of the ejection unit body 32321. The ejection valve 32322 may be configured with elasticity.

When the pressure in the partition insulation space 325 is less than a first pressure, the ejection valve 32322 may be maintained in a closed state. When the pressure in the partition insulation space 325 is greater than the first pressure, the ejection valve 32322 may be maintained in an open state. The first pressure may be a pressure greater than 1 atmosphere (atm).

In the event of a fire in the battery module 30 (see FIG. 14) or the battery cell 36 (see FIG. 15) adjacent to the partition insulation module 320, the partition insulation module 320 may be exposed to heat.

When the partition insulation module 320 is exposed to heat, the pressure in the partition insulation space 325 of the partition insulation module 320 may rise. For example, when the partition insulation module 320 is exposed to heat, at least a portion of the extinguishing agent 3231 contained in the partition insulation space 325 may be converted into vapor, further increasing the pressure in the insulation space 325.

When the ejection valve 32322 is opened while the pressure in the partition insulation space 325 is greater than the first pressure, the extinguishing agent 3231 contained in the partition insulation space 325 may be released to the outside of the partition insulation module 320. The extinguishing agent 3231 released to the outside of the partition insulation module 320 may be dispersed onto the battery module 30 (see FIG. 14) or the battery cell 36 (see FIG. 15) to extinguish the fire.

The ejection unit 3232 may be formed in the partition leg part 3210 without a separate structure. For example, the ejection unit 3232 may mean a portion of the second partition leg plate 3212 having a relatively thin thickness.

For example, the partition leg part 3210 may be made of metal, and when heat is applied to the partition leg part 3210, a portion of the partition leg part 3210 may melt due to the heat.

Since the ejection unit 3232 is a portion of the second partition leg plate 3212 having a relatively thin thickness, it may melt due to the heat. As the ejection unit 3232 melts due to the heat, an opening is formed in the second partition leg plate 3212, and the extinguishing agent 3231 may be released through the opening.

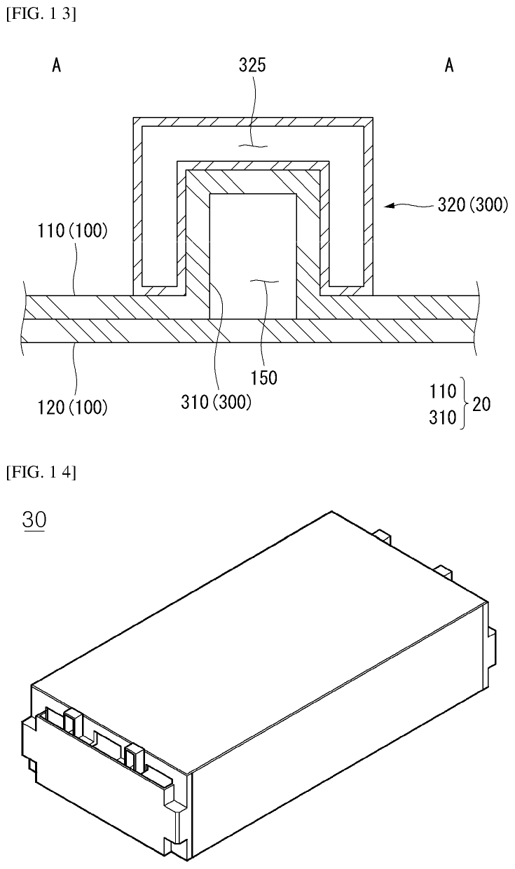

FIG. 13 is a cross-sectional view of the battery pack case shown in FIG. 1, illustrating a state in which a portion of a bottom case is formed integrally with the partition support module.

Referring to FIG. 13, the bottom case 100 may include an upper bottom case 110 and a lower bottom case 120. The upper bottom case 110 may define an upper surface of the bottom case 100.

The upper bottom case 110 may be formed integrally with the partition support module 310. For example, when the metal plate 20 is press-processed, the partition support module 310 and the upper bottom case 110 may be formed integrally with each other.

At least a portion of the support module 310 of the partition unit 300 (see FIG. 2) may be formed integrally with the upper bottom case 110. For example, the partition support module 310 of the first partition unit 301 (see FIG. 1) may be formed integrally with the upper bottom case 110. For example, the partition support module 310 of the second partition unit 302 (see FIG. 2) may be formed integrally with the upper bottom case 110.

Thereby, the bonding force between the partition support module 310 and the bottom case 100 may be enhanced. In addition, the process of manufacturing the partition support module 310 and fixing it to the bottom case 100 may be simplified.

The partition support module 310 may be formed in a shape protruding upward from the upper bottom case 110. For example, the partition support module 310 may be formed in a shape that is bent and extends upwardly from the upper bottom case 110. The partition support module 310 may form a concave shape toward the lower bottom case 120.

The lower bottom case 120 may be coupled to a lower surface of the upper bottom case 110. For example, the lower bottom case 120 and the upper bottom case 110 may be coupled or fixed to each other by welding.

A bottom hollow section 150 may be formed between the lower bottom case 120 and the support module 310. The bottom hollow section 150 may be formed by the partition support module 310 and the lower bottom case 120.

In the event of a fire in the battery module 30 (see FIG. 14) or the battery cell 36 (see FIG. 15) generated on one side of the partition support module 310, the bottom hollow section 150 may help prevent heat caused by a fire from transmitting to the other side of the partition support module 310.

The partition support module 310 may be formed integrally with at least a portion of the bottom case 100. For example, the bottom case 100 may be partitioned into an upper layer and a lower layer, and the support module 310 may be formed integrally with the upper layer of the bottom case 100.

For example, if the metal plate 20 is press-processed, the partition support module 310 and the upper layer of the bottom case 100 may be formed integrally with each other. In other words, the partition support module 310 and the upper bottom case 110 may be formed integrally with each other.

In this case, a void may be formed between the lower layer of the bottom case 100 and the partition support module 310. In other words, the bottom hollow section 150 may be formed between the lower bottom case 120 and the partition support module 310.

FIG. 14 is a perspective view illustrating a battery module according to an embodiment of the present disclosure. FIG. 15 is a perspective view illustrating a battery cell group according to an embodiment of the present disclosure.

Referring to FIGS. 14 and 15, the battery module 30 may include a battery cell group 35. The battery cell group 35 may include the plurality of battery cells 36. The plurality of battery cells 36 may be stacked. The battery cell group 35 may be accommodated in a module case. The battery module 30 may include the battery cell group 35 and the module case.

The battery cell 36 may include a cell body 37. The cell body 37 may be formed in a shape extending from one end to the other end. The cell body 37 may include an electrode assembly. The electrode assembly may include a cathode, an anode and a separator.

The battery cell 36 may include electrode leads 38. A plurality of electrode leads 38 may be positioned at one end and the other end of the cell body 37. The one end and the other end of the cell body 37 may correspond to one end and the other end of the battery cell group 35.

FIG. 16 is a perspective view illustrating the battery modules accommodated in the battery pack case. Referring to FIG. 16, the battery pack 1 may include the battery pack case 10 and the battery modules 30. The battery pack case 10 may accommodate at least one battery module 30. Although not shown in FIG. 16, the plurality of battery modules 30 may be electrically connected.

FIG. 17 is a perspective view illustrating the battery cell groups accommodated in the battery pack case. Referring to FIG. 17, the battery pack 1 may include the battery pack case 10 and the battery cell groups 35. The battery pack case 10 may accommodate at least one battery cell group 35. Although not shown in FIG. 17, the plurality of battery cells 36 (see FIG. 15) may be electrically connected, and a plurality of battery cell groups 35 may be electrically connected.

Referring to FIGS. 16 and 17, the battery module 30 or the plurality of battery cell groups 35 may be accommodated in the battery pack case 10 to provide power to an electric vehicle, etc. As described above, in the event of a fire in the battery module 30 or the battery cell group 35, the battery pack case 10 may effectively suppress the spread of the fire. Therefore, the battery pack 1 according to an embodiment of the present disclosure may operate more stably.

Some embodiments or other embodiments of the present disclosure described above are not mutually exclusive or distinct. The configurations or functions of some embodiments or other embodiments of the present disclosure described above may be selectively combined or used together.

It will be apparent to those skilled in the art that the present disclosure may be embodied in other specific forms without departing from the spirit and essential characteristics of the present disclosure. The detailed description should not be construed as limiting in all respects but should be considered as illustrative. The scope of the present disclosure should be determined by a reasonable interpretation of the appended claims, and all modifications and alterations within the equivalent scope of the present disclosure are included in the scope of the present disclosure.

1. A battery pack case comprising:
a bottom case;
a side case extending upward from a periphery of the bottom case, and forming an accommodation space together with the bottom case; and
a partition unit positioned on an upper surface of the bottom case, and configured to partition the accommodation space,
wherein the partition unit comprises:
a partition support module coupled to the bottom case; and
a partition insulation module coupled to the partition support module, and forming an insulation space as a hollow section therein.

2. The battery pack case according to claim 1, wherein the partition insulation module comprises a partition leg part positioned in the accommodation space and facing the partition support module.

3. The battery pack case according to claim 2, wherein the partition leg part comprises:
a first partition leg plate facing the partition support module; and
a second partition leg plate positioned on an opposite side of the first partition leg plate, and spaced apart from the first partition leg plate.

4. The battery pack case according to claim 3, wherein the partition leg part further comprises a third partition leg plate extending from a lower end of the first partition leg plate to a lower end of the second partition leg plate.

5. The battery pack case according to claim 2, wherein the partition insulation module further comprises a partition head part bent and extending from the partition leg part, and positioned above the partition support module.

6. The battery pack case according to claim 2, wherein the partition leg part comprises a first partition leg part and a second partition leg part, respectively positioned on both sides of the partition support module.

7. (canceled)

8. The battery pack case according to claim 1, wherein the partition insulation module comprises a first partition insulation module and a second partition insulation module, respectively disposed on both sides of the partition support module and spaced apart from each other,
wherein each of the first partition insulation module and the second partition insulation module comprises:
a partition leg part positioned in the accommodation space, and facing the partition support module; and
a partition head part bent and extending from the partition leg part, and facing an upper surface of the partition support module.

9. The battery pack case according to claim 8, wherein the partition leg part comprises:
a first partition leg plate facing the partition support module; and
a second partition leg plate positioned on an opposite side of the first partition leg plate, and spaced apart from the first partition leg plate, wherein the partition head part comprises:
a first partition head plate bent and extending from the first partition leg plate, and facing the upper surface of the partition support module;
a second partition head plate bent and extending from the second partition leg plate, and defining an upper surface of the partition head part; and
a third partition head plate extending from an end of the first partition head plate to an end of the second partition head plate.

10. The battery pack case according to claim 9, wherein the third partition head plate of the first partition insulation module is spaced apart from and positioned to face the third partition head plate of the second partition insulation module.

11. The battery pack case according to claim 10, further comprising an insulation member disposed on an upper surface of the partition support module, and positioned between the first partition insulation module and the second partition insulation module.

12. The battery pack case according to claim 1, wherein the partition support module comprises a first partition support module and a second partition support module, arranged horizontally and spaced apart from each other,
wherein the partition insulation module is placed between the first partition support module and the second partition support module.

13. The battery pack case according to claim 1, wherein the side case comprises:
a side support module having a shape extending upward from an edge portion of the bottom case; and
a side insulation module coupled to the side support module, and forming a side insulation space as a hollow section inside.

14. The battery pack case according to claim 13, wherein the side insulation module comprises a side leg part positioned in the accommodation space and facing the side support module.

15. The battery pack case according to claim 14, wherein the side insulation module further comprises a side head part bent and extending from the side leg part, and positioned above the side support module.

16. The battery pack case according to claim 1, wherein the partition unit further comprises an extinguishing part coupled to the partition insulation module, in communication with the insulation space, and configured to release an extinguishing agent toward the accommodation space when a pressure inside the insulation space is a predetermined pressure or more.

17. The battery pack case according to claim 16, wherein the extinguishing part comprises:
an ejection unit coupled or formed in the partition insulation module in communication with the accommodation space; and
the extinguishing agent contained in the insulation space,
wherein, when the pressure inside the insulation space is less than the predetermined pressure, the ejection unit remains closed, and when the pressure inside the insulation space is the predetermined pressure or more, the ejection unit opens.

18. A battery pack comprising:
a plurality of battery cell groups each containing a plurality of battery cells; and
a battery pack case configured to accommodate a plurality of battery cell groups,
wherein the battery pack case comprises:
a bottom case;
a side case extending upward from a periphery of the bottom case, and forming an accommodation space together with the bottom case; and
a partition unit positioned on an upper surface of the bottom case, and configured to partition the accommodation space,
wherein the partition unit comprises:
a partition support module coupled to the bottom case; and
a partition insulation module coupled to the partition support module and forming an insulation space as a hollow section therein.

19. The battery pack according to claim 18, wherein each of the plurality of battery cell groups is accommodated in a module case to form a battery module, and
the battery module is accommodated in the battery pack case.

20. The battery pack according to claim 18, wherein the pressure in the insulation space is maintained at less than 1 atm.

21. The battery pack according to claim 18,
wherein the partition insulation module comprises a vacuum structure.
